(19) United States
(12) Patent Application Publication
(10) Pub. No.: US 2008/0179910 A1
(43) Pub. Date: Jul. 31, 2008

(54) Shading Device With Holding Element, And Corresponding Vehicle

(75) Inventor: Pascal Fourel, Saint-Malo (FR)

Correspondence Address: SHEWCHUK IP SERVICES, 3356 SHERMAN CT. STE. 102, EAGAN, MN, 55121, US

(73) Assignee: WAGON SAS, Bressuire (FR)

(21) Appl. No.: 11/829,490

(22) Filed: Jul. 27, 2007

(30) Foreign Application Priority Data
Jul. 28, 2006 (FR) 06/06964

(51) Int. Cl. B60J 3/02

(52) U.S. Cl. 296/97.8

(57) ABSTRACT

The invention relates to a vehicle shading device, including a blind sheet capable of moving according to an axis of deployment between a folded position and at least one deployed position, one end of said blind sheet being mounted on a roller tube.

According to the invention, said blind sheet has at least one holding and/or guiding element separated from the lateral edges of said blind sheet and extending parallel to said axis of deployment, and cooperating with a guide rail having a complementary cross-section to that of said holding and/or guiding element, said guide rail being formed in or on a cross-piece extending inside said vehicle.

### FIELD OF THE INVENTION

The field of the invention is that of vehicles, for example motor vehicles, but also buses, truck cabins, and so on.

The invention relates in particular to vehicles with a large window surface, for example at the level of the body roof and/or the windscreen.

More specifically, the invention relates to the shading of such surfaces by means of blind sheets capable of moving between a folded position and at least one deployed position, for example for protection from the sun's rays.

### PRIOR ART

The current tendency, in particular in terms of motor vehicles, is to propose an increasingly large window surface. Thus, in particular, an increasing number of vehicles have been proposed with a body roof equipped with one or more window elements. In some cases, the entire body roof is made of glass or a similar material allowing the sun's rays to pass through. Vehicles equipped with a “plunging” windscreen strongly slanted and/or extending from a portion of the body roof, and having a large surface, have also been proposed.

It is understood that it is thus necessary to provide shading devices making it possible to protect the passenger compartment and its occupants from the sun's rays.

A similar need may exist for areas to be covered and hidden, such as a luggage compartment, in particular for a station wagon or a people mover trunk.

Roller blinds have been used for a long time to shade motor vehicle surfaces.

However, the use of such blinds, for example to shade a windowed body roof, is complex. Indeed, if a blind sheet with a large width and length is used, it becomes deformed and sags under the effect of gravity.

In addition, the windscreens and/or body roofs of motor vehicles are often not flat, but instead curved or bent, at least in the direction of the width, and sometimes also in the direction of the length.

The prior art proposes holding the blind sheet in its deployed position by means of rods. According to a first technique, the rods are secured to the blind sheet. According to a second technique, the rods can be deployed and are secured to the blind sheet only when it is deployed.

A disadvantage of these prior art techniques is that the use of such rods is relatively complex.

Another disadvantage of these prior art techniques is that they are expensive to use.

Yet another disadvantage of these techniques of the prior art is that they do not allow for effective contouring of the curved surface that a windowed body roof and/or a windscreen may have in two directions, in particular in the direction of deployment of the blind sheet.

Another disadvantage of these prior art techniques is that they make it necessary to guide the blind sheet laterally. This is even more difficult since sometimes the windowed body roofs of vehicles have non-parallel contours.

### OBJECTIVES OF THE INVENTION

The invention is intended in particular to overcome these disadvantages of the prior art.

More specifically, an objective of the invention is to provide such a technique that makes it possible to simply and effectively impart on a blind sheet the curved surfaces that a windowed surface may have in two directions, and in particular in the direction of deployment of the shading blind sheet.

The invention is also intended to provide such a technique that makes it possible to deploy a blind sheet as close as possible to a non-planar windowed surface, even when its lateral edges are not parallel.

Another objective of the invention is to provide such a technique that is reliable and robust.

The invention is also intended to provide such a technique that is easy and inexpensive to use.

Another objective of the invention is to propose such a technique that has good ergonomic qualities in particular with regard to the ease of use.

### DESCRIPTION OF THE INVENTION

These objectives, as well as others that will appear below, are achieved by a vehicle shading device, including a blind sheet capable of moving according to an axis of deployment between a folded position and at least one deployed position, one end of said blind sheet being mounted on a roller tube.

According to the invention, said blind sheet has at least one holding and/or guiding element separated from the lateral edges of said blind sheet and extending parallel to said axis of deployment, and cooperating with a guide rail having a complementary cross-section to that of said holding and/or guiding element, said guide rail being formed in or on a cross-piece extending inside said vehicle.

Thus, the invention is based on an entirely novel and non obvious approach to the guiding and holding of a blind sheet, in particular for a windscreen and/or a windowed body roof of a motor vehicle, consisting of suspending the blind sheet from a cross-piece secured to the vehicle, placed in the vicinity of the windscreen and/or the body roof, and having a curved surface substantially equivalent to the curved surface of the windscreen and/or the body roof in the direction of deployment of the blind sheet. In this way, the curved surfaces of the windscreen and/or the body roof in the direction of deployment of the blind sheet, as well as in a transverse direction with respect to the direction of deployment of the blind sheet, are substantially imparted on the blind sheet in a simple and effective manner.

Said holding element advantageously extends substantially over the entire length of said blind sheet.

This approach makes it possible to effectively and simply impart on the blind sheet the longitudinal and the transverse curved surface of the surface to be shaded.

According to another advantageous feature, the blind sheet has a holding and a guiding element that essentially extend at the middle of the blind sheet.

Use of a holding and guiding element at such a position makes it possible to impart to the blind sheet the transverse curve of the surface to be shaded and to effectively hold it.

According to a preferred feature of the invention, said complementary cross-section is substantially triangular or trapezoidal.

The holding element is thus properly guided and held in the rail.

Said holding element is preferably secured to said blind sheet by bonding and/or welding and/or thermo welding and/or stitching.

The holding element can then be effectively secured to the blind sheet simply and inexpensively.

In an advantageous embodiment of the invention, said blind sheet has, at its free end, a pull bar guided by said cross-piece.

This approach makes it possible to facilitate the deployment and the folding of the blind sheet and also to impart on it the transverse curved surface that the surface to be shaded may have.

According to an advantageous feature of the invention, said pull bar includes an element for secure attachment to said cross-piece, capable of sliding along said cross-piece.

The pull bar can thus easily be moved along the cross-piece so as to deploy and fold the blind sheet. This aspect also makes it possible to reduce the mechanical stresses created on the pull bar and consequently to reduce its cross-section and its mass. This in particular has the effect of reducing the loss of headroom at the level of the pull bar and of slightly increasing the passenger space in the vehicle.

In this case, said secure attachment element preferably defines, with said cross-piece, a dovetail-type assembly.

In an alternative of the invention, said vehicle has two lateral rails guiding and/or holding said lateral edges of said blind sheet and/or a pull bar of said blind sheet and/or at least one rod.

This approach makes it possible to effectively guide the edges of the blind sheet, and to facilitate the installation of shading blinds in vehicles in which the windscreen and/or the body roof do not have parallel lateral edges.

Said guiding and/or holding element advantageously has at least one rod for holding said blind sheet.

Said cross-piece preferably has and/or guides at least one rod for holding said blind sheet.

The installation of rods makes it possible to impart, on the blind sheet, the transverse curved surface and the longitudinal curved surface that the surface to be shaded may have.

Advantageously, said cross-piece has means for driving said blind sheet and/or a pull bar of said shading blind sheet.

This feature makes it possible in particular to power-operate the deployment and folding of the blind sheet.

Said blind sheet is preferably intended to shade at least one of the following surfaces:
a windowed body roof;
a windscreen;
a side window;
a rear window;
a luggage compartment.

Said cross-piece advantageously extends longitudinally at least in the vicinity of the windscreen of said vehicle.

It is then possible to easily install a rear-view mirror inside the vehicle by securing it to the cross-piece. It is also possible to easily route the electrical energy at the level of an upper portion of a windscreen.

Said cross-piece advantageously extends longitudinally in the vicinity of the body roof of said vehicle.

It is thus possible to at least partially shade a windowed body roof, and to simply impart, on the blind sheet, the transverse curved surface and/or the longitudinal curved surface that a body roof may have.

The invention also relates to a vehicle equipped with a shading device according to the invention.

### LIST OF FIGURES

Other features and advantages of the invention will appear more clearly on reading the following description of a preferred embodiment, given by way of a simple illustrative and non-limiting example, and the appended drawings, in which:

FIG. 1 shows a top view of an embodiment of a body roof equipped with a holding and/or guiding element according to the invention;

FIG. 2 is a cross-section view according to a transverse axis of the body roof shown in FIG. 1;

FIG. 3 is a cross-section view according to a longitudinal axis of the body roof shown in FIG. 1;

FIG. 4 shows a specific embodiment of a guiding and/or holding element and a cross-piece according to the invention;

FIG. 5 shows a specific embodiment of a lateral rail and a slide according to the invention;

FIG. 6 shows an alternative of an embodiment according to the invention in which the free end of the blind sheet is equipped with a pull bar guided by the cross-piece;

FIG. 7 shows a view from the interior of a vehicle of an alternative of the invention in which the blind sheet is held by light rods;

FIGS. 8A to 8C diagrammatically show, in cross-section views, three examples of cross-sections of a guiding and/or holding element and a cross-piece according to the invention;

FIG. 9 shows an example of an upper windscreen module according to the invention, implementing a cross-piece extending over an upper portion of a windscreen;

FIG. 10 shows an example of a cross-piece according to the invention, on which notches are provided, allowing for the immobilisation of a pull bar in predetermined positions.

### DESCRIPTION OF AN EMBODIMENT OF THE INVENTION

The following embodiment applies to an upper windscreen module in which the blind sheet makes it possible to at least partially shade an upper portion of a windscreen. A person skilled in the art can easily adapt the invention to other implementations, for example when the blind sheet shades a windowed body roof, or at least a portion of the body roof.

### Principle of the Invention

The general principle of the invention is based on the implementation of a cross-piece secured to a vehicle, extending in the vicinity of an upper windscreen portion, and having a rail with which a holding and/or guiding element cooperates, borne by a blind sheet and separated from its lateral edges, so that it is guided and held and substantially cling to the curved surfaces that the windscreen may have in two directions, and in particular in the direction of deployment of the blind sheet and in a transverse direction with respect to the direction of deployment of the blind sheet.

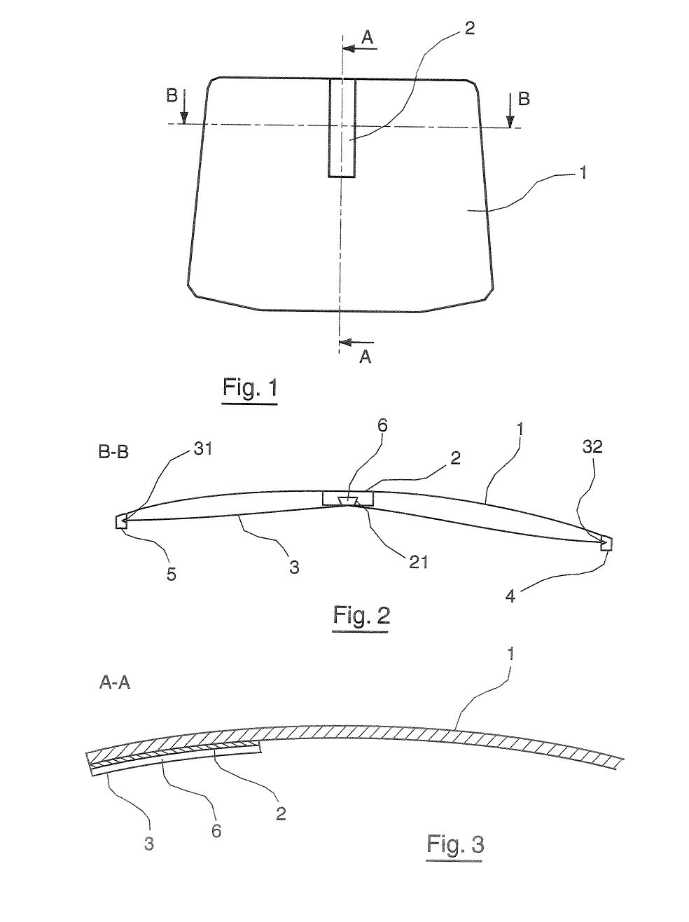

FIG. 1 is a top view of a windscreen 1 of a vehicle, along which a cross-piece or beam 2 extends. This cross-piece 2 is attached under the interior face of the windscreen 1 according to an axis substantially parallel to the longitudinal axis A of the vehicle, and is secured thereto, for example by bonding. Other secure attachment means can be envisaged. The cross-piece 2 can in particular be secured to the structure of the vehicle by means of secure attachment elements provided for this purpose.

FIG. 2 is a cross-section view of the windscreen 1 and the cross-piece 2 shown in FIG. 1, according to axis B.

FIG. 3 is a cross-section view according to axis A of the windscreen 1 and the cross-piece 2 shown in FIG. 1.

As shown in these FIGS. 2 and 3, the windscreen 1 has a transverse curved surface. The windscreen 1 also has a longitudinal curved surface. The proportions of these curved surfaces have been increased so as to make the presentation clearer.

The cross-piece 2 has a central rail 21 open in a direction substantially perpendicular to the windscreen 1, toward the interior of the passenger compartment.

A blind sheet 3 capable of moving between a folded position in which it is wound around a winding tube (not shown), and at least one deployed position in which it at least partially shades the windscreen 1, has, in its upper portion, a holding and/or guiding element 6. The holding and/or guiding element 6 has a shape complementary to that of the central rail 21 so that it can slide therein.

This approach is different from the conventional techniques, which involve rods and/or guides on the lateral edges of the blind sheet. According to the invention, the blind sheet is held and guided by the central portion of the blind sheet.

The technique of the invention can be extended to two or more holding and/or guiding elements 6, in particular if the blind sheet has a large width and/or if the desired curved surface requires it.

The lateral ends 31 and 32 of the blind sheet 3 are preferably held and slide in two lateral rails 4 and 5 that extend in the vicinity of the lateral edges of the windscreen 1.

When the blind sheet passes from its folded position to a deployed position, the holding and/or guiding element 6 slides inside the central rail 21.

In the deployed position, the blind sheet 3 is held in three areas:
the blind sheet 3 is held at its centre by the holding and/or guiding element 6, which cooperates with the central rail 21;
the blind sheet 3 is held by each of its lateral ends 31 and 32, which cooperate with the lateral rails 4 and 5.

The longitudinal curved surface of the windscreen 1 (parallel to the direction of movement of the blind sheet 3) is thus substantially imparted on the blind sheet 3.

As shown in FIG. 3, the fact that the blind sheet is held at its centre by means of the holding and/or guiding element 6, which slides inside the central rail 21, also makes it possible to impart on the blind sheet 3 a transverse curved surface similar to that of the windscreen.

The technique according to the invention therefore enables the blind sheet to be deployed in the vicinity of the windscreen 1 in a simple and effective manner.

The Holding and/or Guiding Element and the Cross-Piece

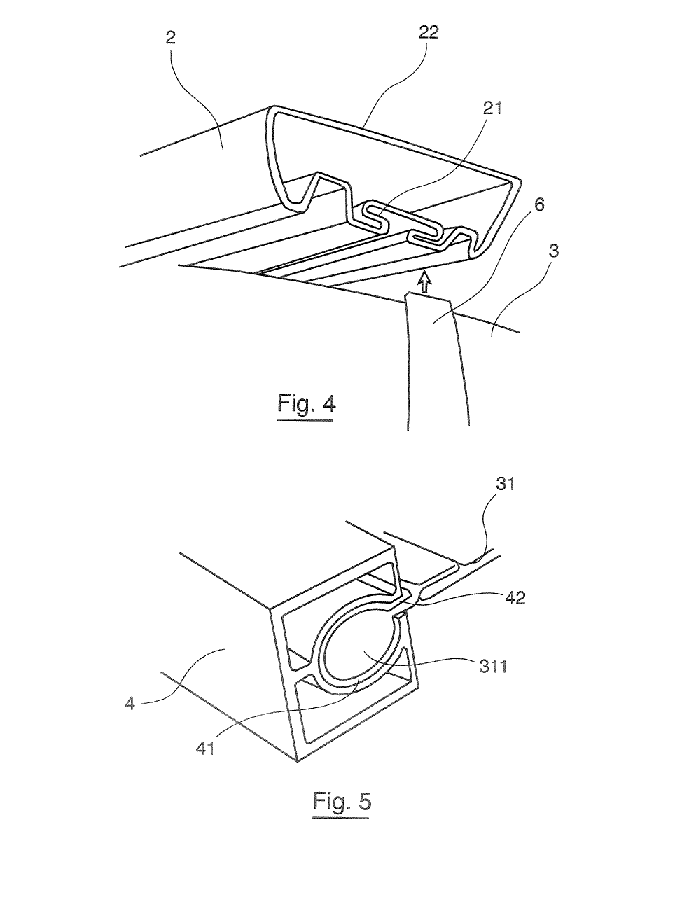

FIG. 4 shows an example of a holding and/or guiding element and a cross-piece according to the invention.

The holding and/or guiding element 6 extends according to the longitudinal axis of the blind sheet 3, essentially along its centre and substantially over its entire length. It is secured thereto, for example by bonding. Other secure attachment modes can of course be envisaged. The holding and/or guiding element 6 can thus, for example, be thermo welded to the blind sheet 3. It can also be sewn thereto.

The holding and/or guiding element 6 is made of a resistant material having in particular good sliding capabilities. It can be made, for example, of polyethylene. It can have, as the case may be, elements facilitating this sliding (glides, balls, needles, etc.).

It preferably has a cross-section of low thickness so that it does not considerably increase the winding diameter of the blind sheet 3 on the winding tube.

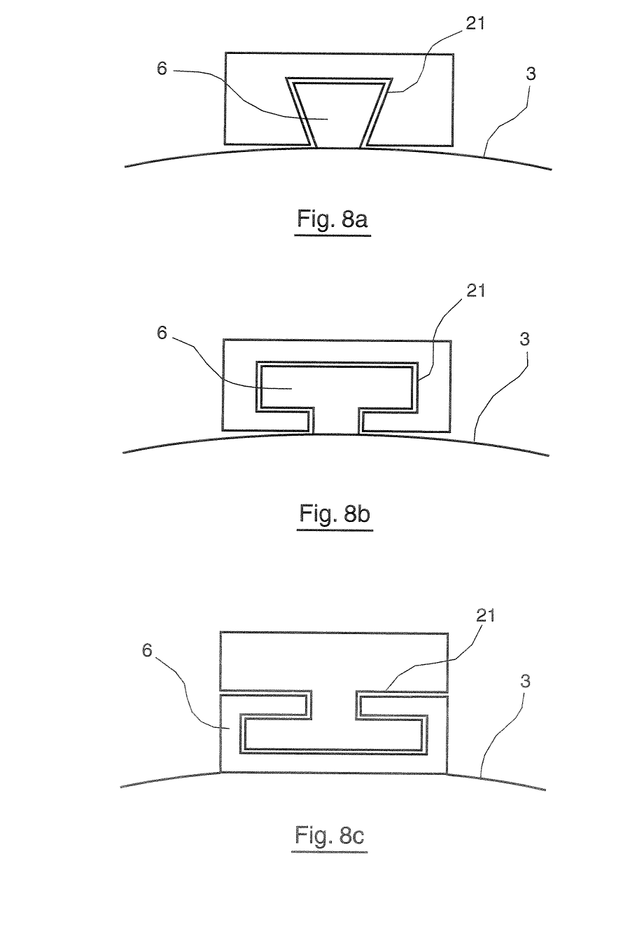

FIGS. 8A to 8C show, by way of indication, different cross-sections that can be envisaged for the holding and/or guiding element 6 and the rail 21.

In an alternative of the invention, the holding and/or guiding element can be constituted by a bead or by a seam connected to the shading blind sheet. This approach makes it possible to obtain a holding and/or guiding element with a relatively low thickness and to thereby reduce the loss of headroom and to increase the passenger space in the vehicle.

The cross-piece 2 has a central cavity of which the contours form in particular the central rail 21. The interior shape of the central rail is complementary to the holding and/or guiding element 6 so that it can slide and be held therein. The central rail 21 and the holding and/or guiding element 6 form a dovetail-type system.

The cross-piece 2 has, in this embodiment, a substantially planar upper face 22, intended to come into contact with the interior face of the body roof 1 to which it is secured, for example, by bonding.

The cross-piece 2 is made of a rigid and robust material. It can in particular be made of an aluminium alloy and be obtained by extrusion and curved so as to have a curved surface substantially equal to the longitudinal curved surface of the body roof. It can also be made of a suitable plastic material such as polypropylene or polyamide.

In an alternative of the invention, the upper face of the cross-piece may not be planar. A wireway (not shown) can thus be provided on the upper surface so as to facilitate the passage of cables and electrical wires, and thus provide electrical energy to equipment placed in the region of the windscreen such as a rear-view mirror, a GPS, etc.

The central cavity can in particular satisfy a cable grommet function so as to facilitate the transport of electrical energy inside the interior of the passenger compartment, in particular in the upper region of the windscreen.

### The Lateral Rails and Slides

FIG. 5 is a cross-section view of a lateral rail 4, 5 inside of which an end 31 of the blind sheet 3 slides, according to an embodiment of the invention.

The rail 4 has a substantially square exterior cross-section and a C-shaped interior cross-section defining a guiding portion 41 opening onto a slot 42.

The rails 4, 5 are preferably made of a rigid and solid material. They can in particular be made of steel, aluminium alloy or plastic materials in particular by extrusion. Any other material and suitable mode of production can be implemented.

The lateral rails 4, 5 are secured to the vehicle structure, for example by means of screws. Other secure attachment techniques, such as clipping and stapling can be used.

A slide 311 is secured to a lateral end 31 of the blind sheet 3 (such a slide is secured to each lateral end of the blind sheet 3). It has a shape complementary to the C-shaped guiding portion 41, so as to be capable of sliding therein, and of guiding and holding each lateral end of the blind sheet 3.

Each slide 311 is secured at each lateral end of the blind sheet 3 by stitching. Other attachment modes can of course be used. The slides can, for example, be secured to the blind sheet by thermo welding, bonding or any other suitable technique.

### Option: Mobile Cross-Piece

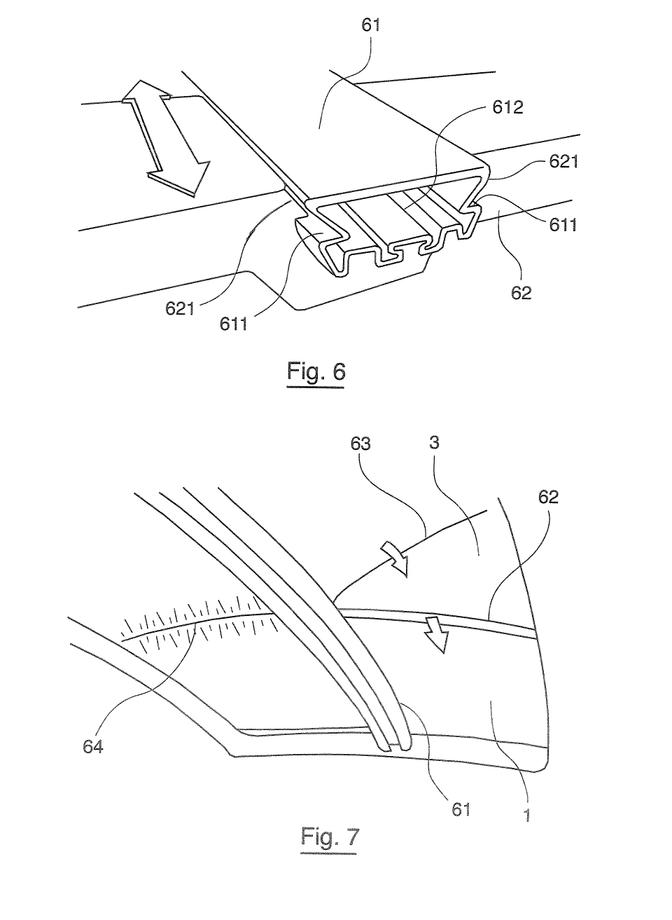

FIG. 6 shows an advantageous option of the invention in which a pull bar 62, shown in the form of a mobile cross-piece, is connected to the free end of the blind sheet 3. The pull bar 62 has a curved surface substantially equal to the transverse curved surface of the windscreen 1.

The cross-piece 61 has two portions forming side rails 611, open in a direction substantially parallel to the body roof, on each side of the cross-piece 61.

The pull bar 62 has two slide portions 621 intended to cooperate with the side rails 611.

The free end of the blind sheet 3 is secured to the pull bar 62, for example by bonding or thermo welding. Other suitable secure attachment modes can be used.

The pull bar 62 is made of a material chosen so as to resist wrench and/or load suspension strains. It can in particular be a filled polymer.

In this embodiment, the pull bar 62 includes an element for secure attachment to the cross-piece, in this case in the form of sliding portions 621. Such a secure attachment element makes it possible to ensure the holding of the pull bar. This has the effect of reducing stress on the pull bar, and therefore of reducing its cross-section and its mass, and of simplifying the system. This also makes it possible to reduce the loss of headroom and to increase the passenger space in the vehicle.

It is of course possible to provide one or more rods designed and mounted in the same way as the pull bar.

The blind sheet 3 can be guided under the cross-piece 61.

In an alternative of the invention, the lateral rails 4, 5 may not be implemented. The lateral ends of the blind sheet 3 are then not guided, but held by the pull bar 62 and, optionally, the rods.

### Other Features and Advantages

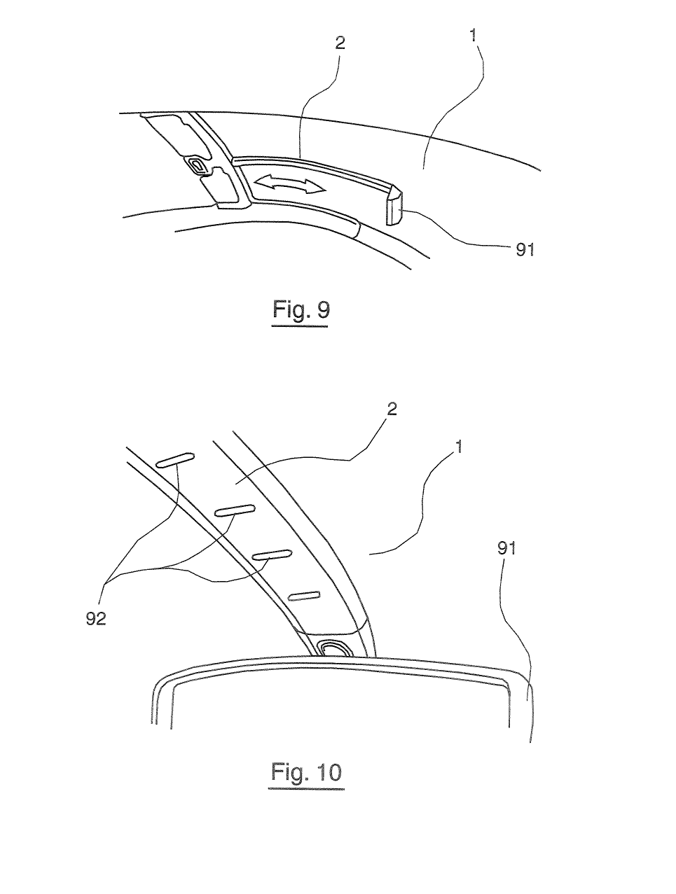

As shown in FIGS. 9 and 10, the cross-piece 2 can enable the easy installation of a rear-view mirror. It is thus no longer necessary to attach the rear-view mirror to the windscreen.

In addition, the rear-view mirror may be equipped with lighting means or implement electrochrome technology without presenting any connection problems insofar as the electrical supply is in the cross-piece.

In addition, the cross-piece can also enable the installation of a rain sensor controlling, for example, the start-up of the windscreen wipers, simply and without presenting any connection problems.

A series of notches 92 can be provided on the face of the cross-piece turned toward the interior of the passenger compartment. These notches enable the immobilisation of the pull bar in predetermined positions. This approach makes it possible to simplify the complex systems conventionally used, enabling the shade to be locked in position. Indeed, very often, the locking mechanisms are located at the ends of the pull bar and require relatively complex mechanics to transmit the movements from an actuator, placed substantially at the centre of the pull bar (for example a handle), toward the lateral locking areas (for example the side rails). The implementation of such locking systems is particularly complex, in particular when the sides of the surface to be shaded are not parallel.

### Alternative: Shading of a Body Roof

In another embodiment, the cross-piece can extend toward the rear of the vehicle on a portion of the body roof or even over its entire length if the body roof is windowed.

In this case, it is possible, as in the case of the upper windscreen module, for the cross-piece to be attached to the interior face of the body roof.

In this specific embodiment, it is also possible for a space to be provided between the body roof and the cross-piece 61, so as to enable the blind sheet 3 to pass through. In this case, the cross-piece 61 is not bonded to the entire body roof, but is attached to it, or to structural elements of the vehicle, at least by its ends.

In this embodiment of the invention, the lateral rails 4, 5 may not be implemented. The lateral ends of the blind sheet 3 are then not guided, but held by the pull bar 62 and, optionally, by rods. This can make it possible in particular to facilitate the installation of shading blinds in vehicles in which the body roof does not have parallel lateral edges.

The blind sheet 3 is advantageously associated with rods 63, 64, which make it possible to impart, on the blind sheet, a curved surface corresponding substantially to the transverse curved surface and to the longitudinal curved surface of the body roof.

These rods can be secured to the cross-piece 61, and be removable, and movably mounted, so that at rest they are collapsed along the cross-piece 61, and are deployed and retract with the passage of the mobile cross-piece a pull bar 62.

Specific actuation means (fingers, snug, racks, etc.) can be provided to control the movement of the rods. It is also possible for the actuation of the rods to be independent of the mobile cross-piece 62, and controlled by the blind sheet 3, or manually or in a power-operated manner, by the user.

In an alternative of the invention, the rods can be secured to the holding and/or guiding element, or to the blind sheet 3.

The cross-piece 61 has an interior cavity 612. This cavity 612 in particular ensures its cable grommet function and enables the transport of electrical energy so as to supply power, for example, to lighting elements housed at the level of the rods 63, 64 (cf. FIG. 7). It can involve, in particular, light emitting diodes, optical fibres or light diffusing bars implementing electroluminescent films. Other lighting means can be implemented. The light rods 63, 64 thus enable light to be diffused inside the passenger compartment and various ambiances to be created.

### Other Applications

The technique according to the invention applies in particular to the shading of windowed body roofs of motor vehicles. It can also apply to the shading of windowed body roofs of other types of vehicles, such as truck cabins, buses, tractors, and so on.

The technique according to the invention can also enable the shading of windowed surfaces other than vehicle body roofs. In particular, this technique can be implemented to at least partially shade large windscreens, in particular windscreens of buses, truck cabins, and so on, without going beyond the scope of this invention.

The invention can also be adapted, for example, to a luggage compartment.

1. Vehicle shading device, including a blind sheet capable of moving according to an axis of deployment between a folded position and at least one deployed position, one end of said blind sheet being mounted on a winding shaft,
characterised in that said blind sheet has at least one holding and/or guiding element separated from the lateral edges of said blind sheet and extending parallel to said axis of deployment,
and cooperating with a guide rail having a complementary cross-section to that of said holding and/or guiding element, said guide rail being formed in or on a cross-piece extending inside said vehicle.

2. Shading device according to claim 1, characterised in that said holding and/or guiding element extends substantially over the entire length of said blind sheet.

3. Shading device according to claim 1, characterised in the said blind sheet has a holding and/or guiding element that extends essentially on the middle of said shield.

4. Shading device according to claim 1, characterised in that said complementary cross-section is substantially triangular or trapezoidal.

5. Shading device according to claim 1, characterised in that said holding and/or guiding element is secured to said blind sheet by bonding and/or welding and/or thermo welding and/or stitching.

6. Shading device according to claim 1, characterised in that said blind sheet has, at its free end, a pull bar guided by said cross-piece.

7. Shading device according to claim 6, characterised in that said pull bar includes an element for secure attachment to said cross-piece, capable of sliding along said cross-piece.

8. Shading device according to claim 7, characterised in that said secure attachment element defines, with said cross-piece, a dovetail-type assembly.

9. Shading device according to claim 1, characterised in that said vehicle has two lateral rails guiding and/or holding said lateral edges of said blind sheet and/or a pull bar of said blind sheet and/or at least one rod.

10. Shading device according to claim 1, characterised in that said guiding and/or holding element has at least one rod for holding said shading blind sheet.

11. Shading device according to claim 1, characterised in that said cross-piece has and/or guides at least one rod for holding said blind sheet.

12. Shading device according to claim 1, characterised in that said cross-piece has means for driving said blind sheet and/or a pull bar of said blind sheet.

13. Shading device according to claim 1, characterised in that said blind sheet is intended to shade at least one of the following surfaces:
a windowed body roof;
a windscreen;
a side window;
a rear window;
a luggage compartment.

14. Shading device according to claim 1, characterised in that said cross-piece extends longitudinally at least in the vicinity of the windscreen of said vehicle.

15. Shading device according to claim 1, characterised in that said cross-piece extends longitudinally in the vicinity of the body roof of said vehicle.

16. Vehicle equipped with at least one shading device including a blind sheet capable of moving according to an axis of deployment between a folded position and at least one deployed position, one end of said blind sheet being mounted on a winding shaft,
said blind sheet having at least one holding and/or guiding element separated from the lateral edges of said blind sheet and extending parallel to said axis of deployment,
and cooperating with a guide rail having a complementary cross-section corresponding to that of said holding and/or guiding element, said guide rail being formed in or on a cross-piece extending inside said vehicle.
